(19) United States
(12) Patent Application Publication
(10) Pub. No.: US 2005/0071367 A1
(43) Pub. Date: Mar. 31, 2005

(54) System and method for displaying patent analysis information

(75) Inventors: Yang He, Shen-Zhen (CN); Chien-Fa Yeh, Tu-Cheng (TW); Chung-I Lee, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/931,234

(22) Filed: Aug. 31, 2004

(30) Foreign Application Priority Data
Sep. 30, 2003 (TW) 092126965

(51) Int. Cl. G06F 17/00

(52) U.S. Cl. 707/102

(57) ABSTRACT

A system for displaying patent analysis information includes an application server (1), a database server (3), and a number of client computers (2). The application server includes a database connecting module (10) for connecting the application server with the database server; a data retrieving module (11) for retrieving relevant data from the database server; a dynamic classifying module (12) for classifying patents into different patent categories and sub-categories; a data identifying module (13) for determining whether there are patents in any patent category or sub-category; a configuration constructing module (14) for constructing a hierarchical histogram of classification of the patents; and a graphics displaying module (15) for displaying the hierarchical histogram. Each category and sub-category occupies an area in the hierarchical histogram directly proportional to a quantity of patents belonging to the category/sub-category. A related method for displaying patent analysis information is also disclosed.

### BACKGROUND OF THE INVENTION

1. Field of the Invention

The present invention relates to computerized systems and methods for analyzing data, and especially to a system and method for analyzing patent data and displaying patent analysis information.

2. Background of the Invention

Patents are becoming more and more important to a manufacturing business's success, especially in today's globalized economy. A good way to make use of patents is to search and analyze public patent databases, which in effect are storehouses of up-to-date technological information. The patent databases provide not only information on technologies, but also information on inventors and assignees of inventions. To search and analyze the patent databases is valuable for conducting activities such as invention licensing, patent infringement litigation, patent enforcement, technical research, and product development.

However, few corporations conduct significant patent searching and analysis. One important reason for this is the difficulty in identifying relevant patents, and the difficulty in analyzing patents. Any major patent database contains an overwhelming number of patents, only a fraction of which are useful to a particular corporation. It is generally problematic for a corporation to efficiently search for useful patents. Even if the corporation finds useful patents, conducting patent analysis manually is a very difficult, tedious and time-consuming task.

Recently, technology for displaying information in image form has developed significantly. For example, U.S. Pat. No. 6,300,957 entitled “Mapping a Node-link Structure to a Rendering Space Beginning from any Node” discloses a method for converting a node-link structure into a hyperbolic tree. Through this technology, vast information can be shown in a simple image.

There are some software tools for patent analysis currently available. However, analysis results generated by these tools tend to be rather simple and of limited relevance to the user. The tools are generally not adequate for analysis of very large numbers of patents required by a major analysis project. Thus the potential usefulness of huge databases of patents available online cannot be fully exploited.

### SUMMARY OF THE INVENTION

A main objective of the present invention is to provide a system and method for displaying patent analysis information which can not only classify patents but also display classification results for various patent categories in a hierarchical histogram.

To accomplish the above objective, a system for displaying patent analysis information in accordance with a preferred embodiment of the present invention comprises an application server, a database server, and a plurality of client computers. The application server comprises: a database connecting module for connecting the application server with the database server; a data retrieving module for retrieving relevant data from the database server; a dynamic classifying module for classifying patents into different patent categories and sub-categories according to a patent classification instruction selected by a user through a client computer; and a data identifying module for determining whether there are patents in any patent category or sub-category. If there are no patents in any patent category or sub-category, the graphics displaying module displays a nil result. If there are patents in certain patent categories or sub-categories, the configuration constructing module constructs a hierarchical histogram, showing corresponding patent categories and sub-categories. Then the graphics displaying module displays the hierarchical histogram to the user. Each category and sub-category occupies an area in the hierarchical histogram directly proportional to a quantity of patents belonging to the category/sub-category.

The present invention also provides a method for displaying patent analysis information. The method comprises the steps of: (1) retrieving all patents related to a patent project; (2) receiving a patent classification instruction, and obtaining corresponding patent categories; (3) reading a patent from the retrieved patent; (4) classifying the patent according to the patent categories, and marking the patent as classified; (5) determining whether all the retrieved patents are marked; (6) identifying whether there are patents in the patent categories if all the retrieved patents are marked; (6) constructing a hierarchical histogram of classification of the patents if there are patents in the patent categories; and (7) displaying the hierarchical histogram.

Other objects, advantages and novel features of the present invention will be drawn from the following detailed description of the preferred embodiment and a preferred method of the present invention with the attached drawings, in which:

### BRIEF DESCRIPTION OF THE DRAWINGS

FIG. 1 is a schematic diagram of hardware configuration of a system for displaying patent analysis information in accordance with the preferred embodiment of the present invention;

FIG. 2 is a schematic diagram showing main software function modules of an application server of the system of FIG. 1;

FIG. 3 is a flowchart of the preferred method for displaying patent analysis information according to the present invention; and

FIG. 4 is a schematic diagram of an exemplary hierarchical histogram according to the present invention.

### DETAILED DESCRIPTION OF THE INVENTION

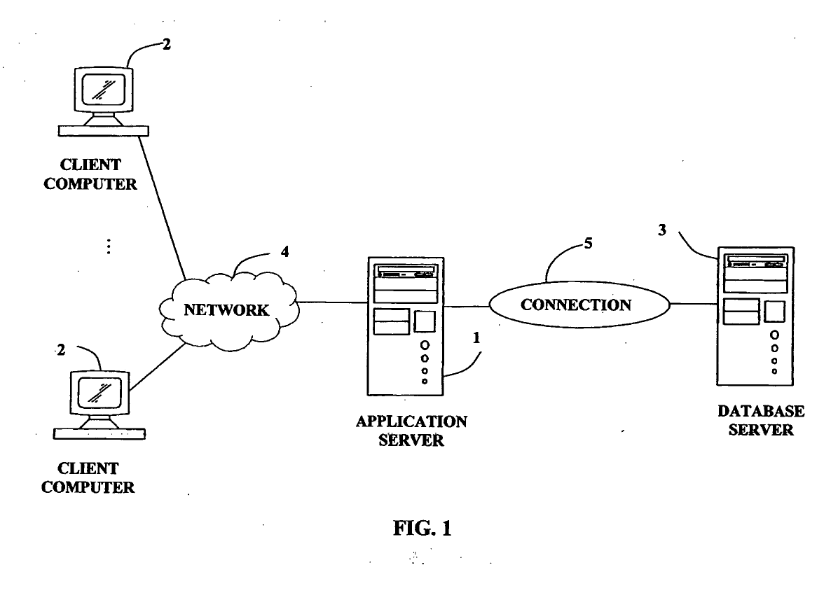

FIG. 1 is a schematic diagram of hardware configuration of a system for displaying patent analysis information (hereinafter, “the system”) in accordance with the preferred embodiment of the present invention. The system comprises an application server 1, a plurality of client computers 2, a database server 3, a network 4, and a connection 5. The application server 1 has a plurality of software functional modules installed therein for classifying patents, constructing classification configurations, and displaying the patents of various categories in a hierarchical histogram. Each client computer 2 provides an interactive user interface for users to input instructions, and for displaying results of implementation of such instructions. The database server 3 contains a database therein for storing all data on the patents, and is also used for managing the processing of the data. Such processing includes reading, writing, deleting, modifying, and backing up the data.

The client computers 2 are connected to the application server 1 via the network 4. The network 4 may be an intranet, the Internet, or any other suitable type of communications link. The application server 1 is connected to the database server 3 via the connection 5, which is a database connectivity such as an Open Database Connectivity (ODBC) or a Java Database Connectivity (JDBC).

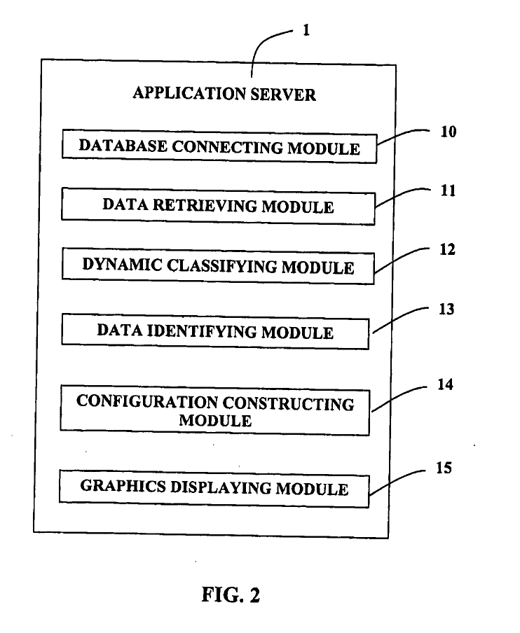

FIG. 2 is a schematic diagram showing main software function modules of the application server 1. The application server 1 comprises a database connecting module 10, a data retrieving module 11, a dynamic classifying module 12, a data identifying module 13, a configuration constructing module 14, and a graphics displaying module 15.

The database connecting module 10 is used for connecting the application server 1 with the database server 3. The data retrieving module 11 is used for retrieving relevant data from the database server 3. In the preferred embodiment of the present invention, the data retrieving module 11 can access data on patents of various projects and corresponding patent classification information. Data on each patent include: a title, an abstract, a publication date, a patent number, an application date, an assignee name, and so on.

In the preferred embodiment of the present invention, the patents can be divided into a plurality of separate projects. Each project comprises at least one patent. When two or more patents belong to a same project, the patents may have at least one common characteristic. The common characteristic may, for example, be that the patents are filed by a same assignee or a same inventor. The dynamic classifying module 12 is used for classifying the patents into different patent categories according to a patent classification instruction selected by a user through a client computer 2. For example, the dynamic classifying module 12 can classify the patents according to their fields of technology, assignee names, or application dates.

The data identifying module 13 is used for determining whether there are patents in any patent category of a project. If no patents are in any patent category, the graphics displaying module 15 displays a nil result. If there are patents in certain patent categories, the configuration constructing module 14 constructs a hierarchical histogram, showing corresponding patent categories and sub-categories. Then the graphics displaying module 15 displays the hierarchical histogram to the user. Each category or sub-category occupies an area in the hierarchical histogram according to a quantity of patents belonging to the category/sub-category. That is, the area of each category/sub-category is directly proportional to a number of patents belonging to the corresponding category/sub-category.

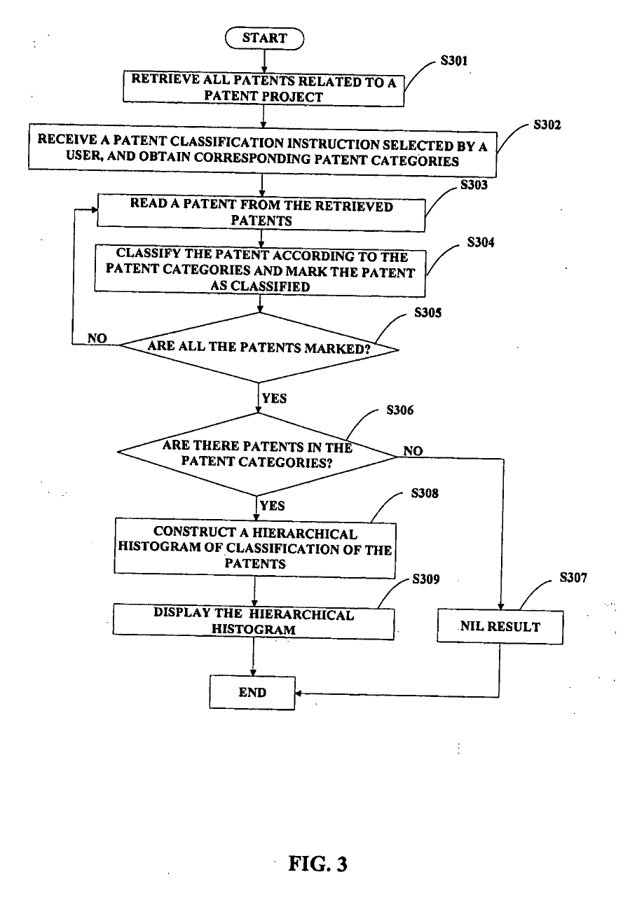

FIG. 3 is a flowchart of a preferred method for displaying patent analysis information according to the present invention. In step S301, the database connecting module 10 connects the application server 1 with the database server 3. The data retrieving module 11 retrieves all patents related to a patent project from the database server 3. In step S302, the application server 1 receives a patent classification instruction selected by a user through a client computer 2, and obtains corresponding patent categories according to the patent classification instruction. The classification instruction may comprise only one patent category. However, for the purposes of better illustrating the preferred method, it will be assumed that the classification instruction comprises a plurality of patent categories and a plurality of patent sub-categories. In step S303, the data retrieving module 11 reads a patent from the retrieved patents. In step S304, the dynamic classifying module 12 classifies the patent according to the patent categories, and marks the patent with a classification label such as a check to indicate that the patent has been classified. In step S305, the dynamic classifying module 12 determines whether all the patents retrieved have been marked with classification labels. If there are patents that are not marked with classification labels, the procedure returns to the step S303 in respect of such patents, and the data retrieving module 11 reads a next patent from the retrieved patents. In step S306, if and when all the patents are marked with classification labels, the data identifying module 13 determines whether there are patents in the patent categories. In step S307, if there are no patents in any patent category, the graphics displaying module 15 displays a nil result. If there are patents in certain patent categories, in step S308, the configuration constructing module 14 constructs a hierarchical histogram according to the patent categories and their respective patent quantities. In step S309, the graphics displaying module 15 displays the hierarchical histogram to the user.

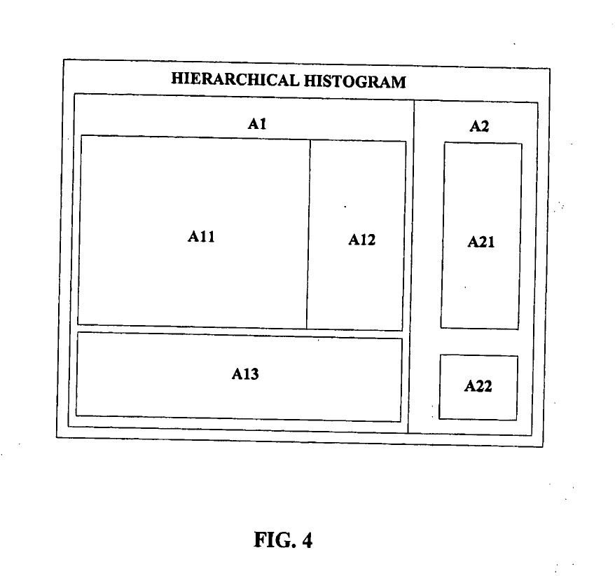

FIG. 4 is a schematic diagram of an exemplary hierarchical histogram in accordance with the present invention. The hierarchical histogram comprises two patent categories: A1 and A2. Category A1 is divided into three sub-categories: A11, A12, and A13. Category A2 is divided into two sub-categories: A21 and A22. Category A1 and category A2 are at a same hierarchical level, and represent two different fields of technology. Further, category A1 and category A2 are at the top of the hierarchical structure, and can be considered as parent categories. Sub-categories A11, A12, A13, A21 and A22 are all child categories.

Although the present invention has been specifically described on the basis of a preferred embodiment and preferred method, the invention is not to be construed as being limited thereto. Various changes or modifications may be made to said embodiment and method without departing from the scope and spirit of the invention.

1. A system for analyzing patent information, the system comprising an application server, one or more client computers, and a database server, wherein the application server comprises:
a data retrieving module for retrieving relevant data from the database server;
a dynamic classifying module for classifying patents into different patent categories and sub-categories;
a configuration constructing module for constructing a hierarchical histogram according to the patent categories and sub-categories and respective quantities of patents belonging to each category and sub-category; and
a graphics displaying module for displaying the hierarchical histogram;
wherein each category and sub-category occupies an area in the hierarchical histogram directly proportional to a quantity of patents belonging to the category/sub-category.

2. The system according to claim 1, wherein the application server further comprises a database connecting module for connecting the application server with the database server.

3. The system according to claim 1, wherein the application server further comprises a data identifying module for determining whether there are patents in any patent category or sub-category.

4. A method for analyzing patent information, the method comprising the steps of: retrieving all patents related to a patent project;
receiving a patent classification instruction, and obtaining corresponding patent categories;
reading a patent from the retrieved patents;
classifying the patent according to the patent categories, and marking the patent as classified;
determining whether all the retrieved patents are marked;
identifying whether there are any patents in the patent categories if all the retrieved patents are marked;
constructing a hierarchical histogram of classification of the patents if there are one or more patents in the patent categories; and
displaying the hierarchical histogram.

5. The method according to claim 4, further comprising the step of:
displaying a nil result if there are no patents in the patent categories.

6. The method according to claim 4, further comprising the step of:
reading another patent from the retrieved patents if not all the retrieved patents are marked, classifying said other patent according to the patent categories, and marking said other patent as classified.

7. The method according to claim 4, wherein each category occupies an area in the hierarchical histogram directly proportional to a quantity of patents belonging to the category.

8. A method for analyzing patent information, the method comprising the steps of:
retrieving said patent information based on at least one inquiry of a patent-analyzing project;
retrieving classifying information from a database server, and expanding said classifying information in a form of a hierarchical histogram;
classifying patents from said patent information according to comparison of said classifying information and said patent information, and marking each of said patents in said hierarchical histogram; and
displaying said hierarchical histogram for further analysis need.

9. The method according to claim 8, further comprising the step of displaying a nil mark for a category from said classifying information in said hierarchical histogram in a condition that none of said patents is classified to said category.

10. The method according to claim 8, further comprising the step of displaying a category from said classifying information proportionally based on a ratio of a number of said patents classified in said category to a total number of said patents.
